(19) United States
(12) Patent Application Publication
(10) Pub. No.: US 2017/0326959 A1
(43) Pub. Date: Nov. 16, 2017

(54) Vehicle Cover Assembly

(71) Applicant: Willie Taylor, Columbia, SC (US)

(72) Inventor: Willie Taylor, Columbia, SC (US)

(21) Appl. No.: 15/154,089

(22) Filed: May 13, 2016

(51) Int. Cl. B60J 11/04

(52) U.S. Cl. CPC B60J 11/04

(57) ABSTRACT

A vehicle cover assembly includes a tarp that may be positioned to cover a vehicle. The tarp is substantially comprised of a resiliently compressible material. Thus, the tarp absorbs impact energy thereby facilitating the tarp to inhibit the vehicle from is damaged by a projectile. The tarp is substantially comprised of a non-abrasive material. Thus, the tarp resists scratching the vehicle when the tarp is positioned to cover the vehicle.

### BACKGROUND OF THE DISCLOSURE

### Field of the Disclosure

The disclosure relates to cover devices and more particularly pertains to a new cover device for protecting a vehicle from hail damage.

### SUMMARY OF THE DISCLOSURE

An embodiment of the disclosure meets the needs presented above by generally comprising a tarp that may be positioned to cover a vehicle. The tarp is substantially comprised of a resiliently compressible material. Thus, the tarp absorbs impact energy thereby facilitating the tarp to inhibit the vehicle from is damaged by a projectile. The tarp is substantially comprised of a non-abrasive material. Thus, the tarp resists scratching the vehicle when the tarp is positioned to cover the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an exploded perspective view of a vehicle cover assembly according to an embodiment of the disclosure.

FIG. 2 is a bottom view of an embodiment of the disclosure.

FIG. 3 is a phantom perspective view of an embodiment of the disclosure.

FIG. 4 is a cross sectional view taken along line 4-4 of FIG. 3 of an embodiment of the disclosure.

FIG. 5 is a perspective in-use view of an embodiment of the disclosure.

### DESCRIPTION OF THE PREFERRED EMBODIMENT

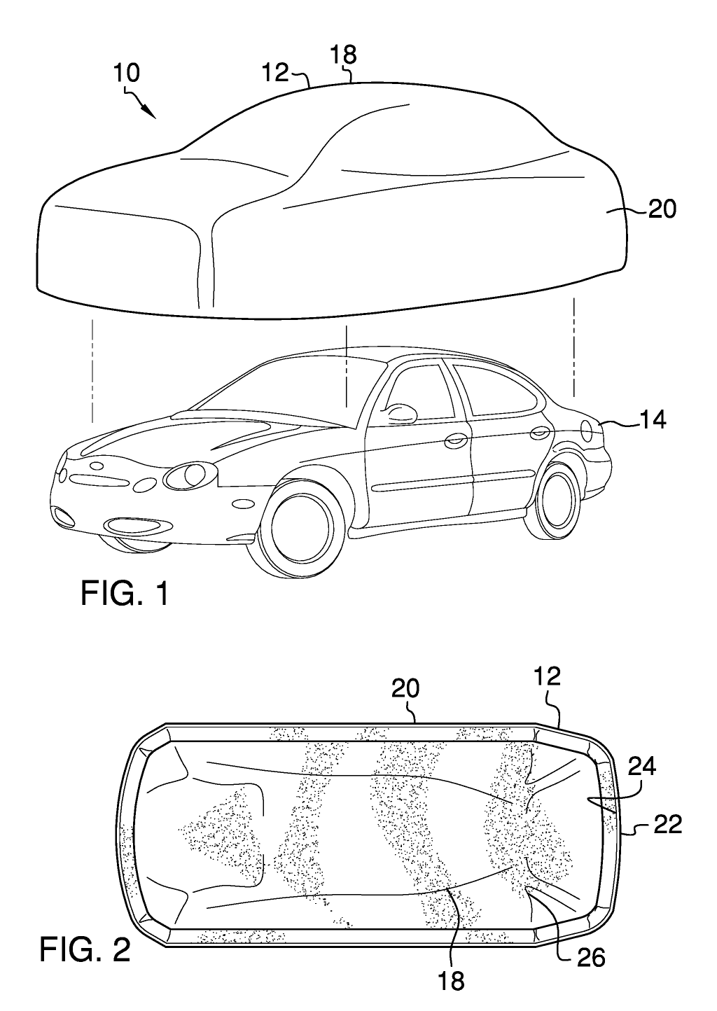

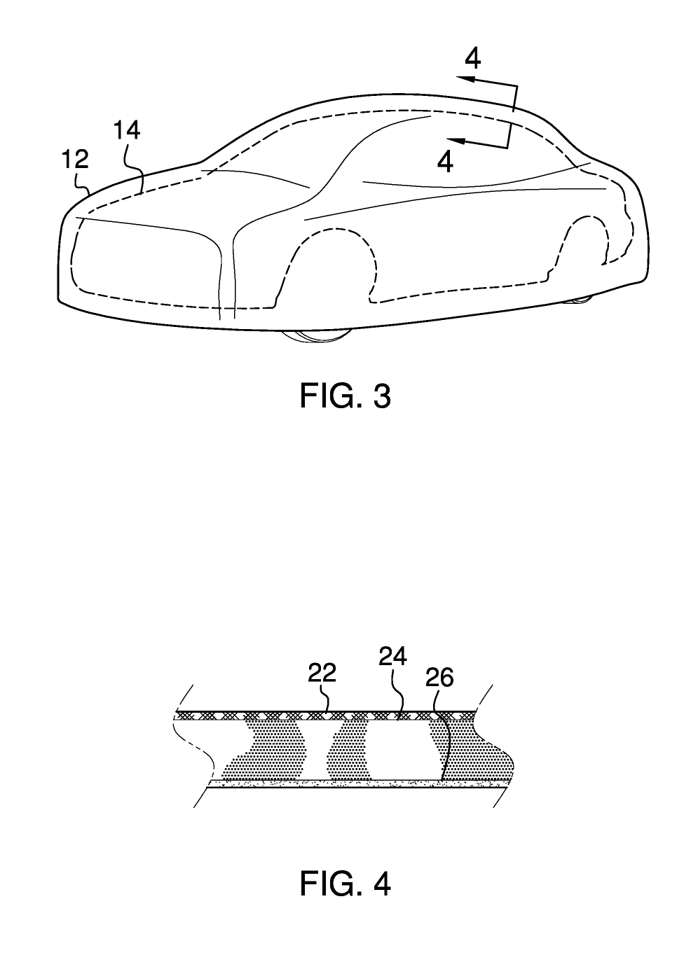

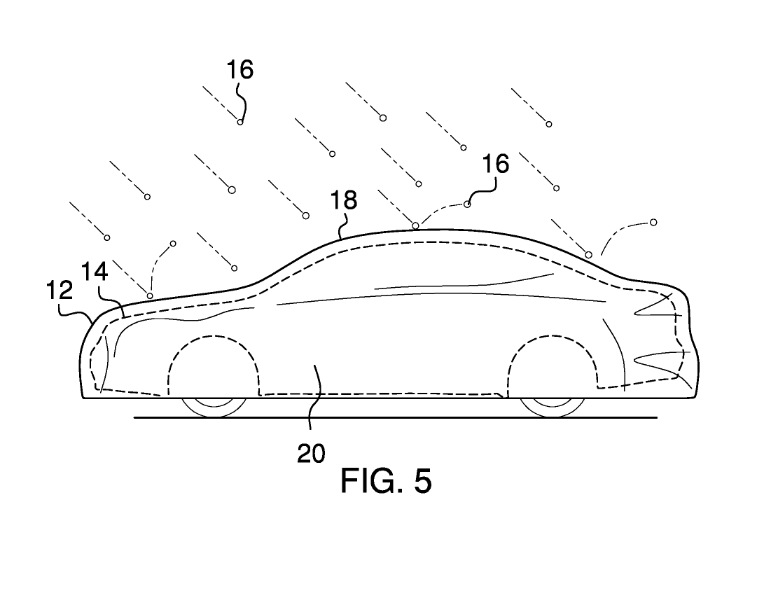

With reference now to the drawings, and in particular to FIGS. 1 through 5 thereof, a new cover device embodying the principles and concepts of an embodiment of the disclosure and generally designated by the reference numeral 10 will be described.

As best illustrated in FIGS. 1 through 5, the vehicle cover assembly 10 generally comprises a tarp 12 that may be positioned to cover a vehicle 14. The vehicle 14 may be a passenger vehicle or the like. The tarp 12 is substantially comprised of a resiliently compressible material. Thus, the tarp 12 may absorb impact energy thereby facilitating the tarp 12 to inhibit the vehicle 14 from being damaged by a projectile 16. The projectile 16 may comprise hail or the like. The tarp 12 is substantially comprised of a non-abrasive material. Thus, the tarp 12 resists scratching the vehicle 14 when the tarp 12 is positioned to cover the vehicle 14.

The tarp 12 has an upper side 18 and a peripheral side 20 extending downwardly from the upper side 18. The upper side 18 rests on the vehicle 14 when the tarp 12 is positioned to cover the vehicle 14. The peripheral side 20 surrounds the vehicle 14 when the tarp 12 is positioned to cover the vehicle 14. The tarp 12 comprises a top layer 22, a middle layer 24 and a bottom layer 26. The bottom layer 26 abuts the vehicle 14 when the tarp 12 is positioned to cover the vehicle 14.

The top layer 22 is comprised of a fluid impermeable material such as polyvinylchloride or the like. Thus, the tarp 12 inhibits the vehicle 14 from getting wet when the tarp 12 is positioned to cover the vehicle 14. The middle layer 24 is comprised of the resiliently compressible material. The resiliently compressible material may comprise memory foam or the like. The bottom layer 26 is comprised of the non-abrasive material. The non-abrasive material may comprise cotton fleece or the like.

In use, the tarp 12 is positioned to cover the vehicle 14 when the vehicle 14 is parked outside. Thus, the tarp 12 inhibits the vehicle 14 from becoming wet from rain or the like. The middle layer 24 absorbs the impact energy from the projectile 16. Thus, the tarp 12 inhibits the vehicle 14 from being damaged by the projectile 16. The bottom layer 26 inhibits the vehicle 12 from being scratched when the tarp 12 is positioned to cover the vehicle 14. The tarp 12 is removed from the vehicle 14 when the vehicle is driven.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A vehicle cover assembly being configured to protect the vehicle from impact damage, said assembly comprising:
a tarp being configured to be positioned to cover a vehicle, said tarp being substantially comprised of a resiliently compressible material wherein said tarp is configured to absorb impact energy thereby facilitating said tarp to inhibit the vehicle from being damaged by a projectile, said tarp being substantially comprised of a non-abrasive material wherein said tarp is configured to resist scratching the vehicle when said tarp is positioned to cover the vehicle, wherein said tarp comprises a top layer, a middle layer and a bottom layer, said bottom layer being configured to abut the vehicle when said tarp is positioned to cover the vehicle, wherein said middle layer is comprised of said resiliently compressible material, said resiliently compressible material being memory foam.

2. The assembly according to claim x, wherein said tarp has an upper side and a peripheral side extending downwardly from said upper side, said upper side being configured to rest on the vehicle when said tarp is positioned to cover the vehicle, said peripheral side being configured to surround the vehicle when said tarp is positioned to cover the vehicle.

3. (canceled)

4. The assembly according to claim 1, wherein said top layer is comprised of a fluid impermeable material wherein said tarp is configured to inhibit the vehicle from getting wet when said tarp is positioned to cover the vehicle.

5. (canceled)

6. The assembly according to claim 1, wherein said bottom layer is comprised of said non-abrasive material.

7. A vehicle cover assembly being configured to protect the vehicle from impact damage, said assembly comprising:
a tarp being configured to be positioned to cover a vehicle, said tarp being substantially comprised of a resiliently compressible material wherein said tarp is configured to absorb impact energy thereby facilitating said tarp to inhibit the vehicle from being damaged by a projectile, said tarp being substantially comprised of a non-abrasive material wherein said tarp is configured to resist scratching the vehicle when said tarp is positioned to cover the vehicle, said tarp having an upper side and a peripheral side extending downwardly from said upper side, said upper side being configured to rest on the vehicle when said tarp is positioned to cover the vehicle, said peripheral side being configured to surround the vehicle when said tarp is positioned to cover the vehicle, said tarp comprising a top layer, a middle layer and a bottom layer, said bottom layer being configured to abut the vehicle when said tarp is positioned to cover the vehicle, said top layer being comprised of a fluid impermeable material wherein said tarp is configured to inhibit the vehicle from getting wet when said tarp is positioned to cover the vehicle, said middle layer being comprised of said resiliently compressible material, said resiliently compressible material being memory foam, said bottom layer being comprised of said non-abrasive material.
